(19) United States
(12) Patent Application Publication
(10) Pub. No.: US 2025/0283548 A1
(43) Pub. Date: Sep. 11, 2025

(54) PRESSURE EQUALIZATION APPARATUS AND USE THEREOF

(71) Applicant: Carl Freudenberg KG, Weinheim (DE)

(72) Inventors: Christopher SCHÄFER, Ober-Ramstadt (DE); Julia Elisa SCHÜßLER, Groß-Umstadt (DE)

(21) Appl. No.: 18/906,242

(22) Filed: Oct. 4, 2024

(30) Foreign Application Priority Data
Mar. 6, 2024 (DE) 10 2024 106 452.8

(51) Int. Cl. F16K 24/04

(52) U.S. Cl. CPC F16K 24/04

(57) ABSTRACT

A pressure equalization apparatus, including a grid-shaped housing with a gas passage opening which connects an inner side and an outer side of the pressure equalization apparatus in a flow-conducting manner in a flow direction depending on a differential pressure. The gas passage opening is covered by an inner membrane, arranged toward the inner side, and an outer membrane, arranged toward the outer side, the inner and outer membranes being arranged in a gas-permeable manner and in a functional series circuit with respect to one another. The inner and outer membranes are arranged at a spacing adjacently with respect to one another, as viewed in the flow direction between the inner side and the outer side. A gas-permeable first protective structure is connected functionally upstream of the inner membrane on a side which faces the inner side, and/or a gas-permeable second protective structure is arranged in the spacing.

### CROSS REFERENCE TO RELATED APPLICATIONS

This application claims benefit to German Patent Application No. DE 10 2024 106 452.8, filed on Mar. 6, 2024, which is hereby incorporated by reference herein.

### FIELD

The invention relates to a pressure equalization apparatus and a use of the pressure equalization apparatus.

### BACKGROUND

DE 10 2021 102 444 A1 has disclosed a pressure equalization apparatus of this type, with an inner side and an outer side which are connected by way of a gas passage opening in a manner which is dependent on the differential pressure and conducts flow. The gas passage opening is covered by two gas-permeable membranes which are arranged on that side of the gas passage opening which faces the outer side and in each case comprise at least one nonwoven layer. The membrane which faces the inner side comprises a nonwoven layer which has fibers which are coated substantially completely by a coating made from an elastomer. As a result, this membrane has oil-repellent properties.

The inner membrane covers the gas passage opening on that side of the gas passage opening which faces the outer membrane. The inner side of the inner membrane directly faces the inner side of the pressure equalization apparatus and therefore the interior of a machine housing, and can therefore be loaded directly with medium from the machine housing. If liquid media such as, for example, oil are situated on the inner side of the pressure equalization apparatus, that is to say in the interior of a machine housing which is provided with the pressure equalization apparatus, it has to be prevented that the liquid medium passes from the inner side through the pressure equalization apparatus to the outer side and therefore into the surroundings.

In the case of pressure equalization apparatuses with only one membrane between the inner side and the outer side made from a conventional, porous PTFE material, the pressure equalization apparatus would function satisfactorily in the new state. The membrane acts like a filter. As the service life of a PTFE membrane of this type increases, its pores become clogged as a result of the medium, in particular if this is oil. As a consequence, the gas permeability of the PTFE membrane is impaired, and the differential pressure between the inner side and the outer side increases to an undesired extent. A loss of the watertightness is also possible.

In order to ensure satisfactory pressure equalization in the long term, the fibers of the membrane which faces the inner side are substantially completely coated by a coating made from an elastomer in the case of the previously known pressure equalization apparatus.

### SUMMARY

In an embodiment, the present disclosure provides a pressure equalization apparatus, comprising a grid-shaped housing with a gas passage opening which connects an inner side and an outer side of the pressure equalization apparatus in a flow-conducting manner in a flow direction depending on a differential pressure. The gas passage opening is covered by an inner membrane, arranged toward the inner side, and an outer membrane, arranged toward the outer side, the inner and the outer membrane being arranged in each case in a gas-permeable manner and in a functional series circuit with respect to one another. The inner membrane and the outer membrane are arranged at a spacing adjacently with respect to one another, as viewed in the flow direction between the inner side and the outer side. A gas-permeable first protective structure is connected functionally upstream of the inner membrane on a side which faces the inner side, and/or a gas-permeable second protective structure is arranged in the spacing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary embodiment of a pressure equalization apparatus;

FIG. 2 shows an exemplary embodiment of a pressure equalization apparatus with a varied second protective structure; and

FIG. 3 shows an exemplary embodiment of a pressure equalization apparatus with a varied first and second protective structures.

### DETAILED DESCRIPTION

In an embodiment, the present disclosure provides a pressure equalization apparatus of the type mentioned at the outset in such a way that the membranes in the pressure equalization apparatus have consistently satisfactory use properties during a long service life, in particular that the membranes are satisfactorily protected against loading with medium from a machine housing which is assigned the pressure equalization apparatus. As a result of this protection of the membranes, the pressure equalization apparatus is also intended to have consistently satisfactory use properties during a long service life by virtue of the fact that the gas permeability of the membranes is not impaired significantly with an increasing service life of the pressure equalization apparatus.

Moreover, the use of the pressure equalization apparatus is intended to be stated.

In order to achieve the foregoing, a pressure equalization apparatus is provided, comprising a grid-shaped housing with a gas passage opening which connects an inner side and an outer side of the pressure equalization apparatus in a flow-conducting manner in the flow direction depending on the differential pressure, the gas passage opening being covered by an inner membrane, arranged toward the inner side, and an outer membrane, arranged toward the outer side, the inner and the outer membrane being arranged in each case in a gas-permeable manner and in a functional series circuit with respect to one another, and the inner and the outer membrane being arranged at a spacing adjacently with respect to one another, as viewed in the flow direction between the inner side and the outer side, and a gas-permeable first protective structure being connected functionally upstream of the inner membrane on the side which faces the inner side, and/or a gas-permeable second protective structure being arranged in the spacing.

The first protective structure ensures that medium from the interior of the machine housing first of all impinges on the protective structures before the medium passes in the direction of the outer side. As a result, the inner membrane is not loaded directly and immediately with the medium. The risk of the inner membrane being penetrated by way of the medium is minimized by the first protective structure.

As a result, the outer membrane which is more sensitive than the inner membrane is protected twice, namely by way of the first protective structure and the inner membrane, and as a result is protected satisfactorily against loading with the medium.

Furthermore, the protection of the outer membrane is improved if the second protective structure is used in addition to the first protective structure. Medium which passes through the inner membrane on its outer side despite the first protective structure is impeded from penetrating to the outer membrane by way of the second protective structure.

The two membranes are each functionally individualized, the inner membrane being configured to protect the outer membrane. The inner membrane protects the outer membrane together with the first protective structure against direct loading with medium which is received in the interior of a machine housing, for example against loading with oil.

As a result, the outer membrane can be of simple construction. For example, it can comprise PTFE or ePTFE materials which, without the protection by way of at least one of the protective structures and the inner membrane, would react to loading with oil with an impairment of the use properties thereof, in particular with an impairment of the air permeability thereof.

This impairment of the use properties is prevented by way of the inner membrane and the first protective structure which is connected functionally upstream of the inner membrane, and/or by way of the second protective structure which is arranged in the spacing.

As a result of this particularly effective protection of the outer membrane, the latter retains its satisfactory gas permeability, even during a long service life of the pressure equalization apparatus.

The inner and the outer membrane are arranged at a spacing adjacently with respect to one another, as viewed in the flow direction between the inner and the outer side. The risk of the outer membrane being loaded with media which impair its use properties is reduced. The spacing is advantageous because the inner membrane is also gas-permeable and, as a result, also breathes depending on the differential pressure in its oil-loaded state. As a result, oil can also pass to the upper side of the inner membrane which faces the outer membrane.

The risk of loading of the outer membrane on its side which faces the inner membrane is even then minimized by way of the spacing between the membranes and, moreover, by way of the second protective structure which is arranged in the spacing.

Further improved protection of the outer membrane against loading with medium from the interior of a machine housing is therefore achieved by virtue of the fact that the second protective structure is arranged in the spacing.

The second protective structure can be formed by way of an annular collar which delimits the gas passage opening on the outer peripheral side.

The collar can be of funnel-shaped configuration.

It is advantageous here that there is a great opening for breathing as a result. The collar can be configured in one piece, for example using injection molding. In the case of horizontal mounting, oil which is possibly present is collected at the deepest point and drips back.

It can be provided in accordance with another refinement that the second protective structure is of labyrinthine configuration.

It is advantageous here that there is likewise a great opening for breathing, and that oil droplets first of all impinge onto the protective structure before they pass to the outer membrane.

Moreover, it is advantageous that a labyrinthine protective structure is a separate component and, as a result, there is a high design flexibility of the protective structure.

The first and/or second protective structure can have apertures. It is advantageous here that the protective structures have a satisfactory gas permeability. The breathing activity can be adapted to the respective conditions of the application by way of the number and the design of the apertures. A small opening cross section of the apertures ensures that the risk of relatively large oil droplets penetrating is minimized. The second protective structure can be configured from the same material and in one piece with the housing.

The gas permeability of the two membranes is not impaired by way of the above-described refinements, but the outer membrane is effectively protected against loading with medium which is situated on that surface of the inner membrane which is arranged in the direction of the outer membrane.

The second protective structure can be configured with an inner and an outer fastening projection for fastening the inner and the outer membrane, the fastening projections extending in the flow direction in an opposed manner with respect to one another. By way of the fastening projections, the membranes are held reliably at a spacing during the use as intended of the pressure equalization apparatus, in particular when there is a differential pressure between the inner and the outer side and the pressure equalization apparatus is functioning.

This is also helped if the membranes are arranged on sides of the second protective structure which face away from one another.

The second protective structure and the fastening projections are preferably configured so as to merge in one piece into one another and from the same material. The second protective structure, the fastening projections and the housing are further preferably configured so as to merge in one piece into one another and from the same material. As a result of a configuration of this type, the production of the pressure equalization apparatus is possible simply and inexpensively, as is its assembly. The pressure equalization apparatus has a simple construction with a small number of parts.

The housing preferably comprises a tough, polymeric material. Housings of this type can be produced simply and inexpensively, and have only a low weight.

The housing can have an inner side which faces the membranes and has an oleophobic coating. It is advantageous here that a possible adhesion and creepage of medium from the machine housing, for example oil, along the housing of the pressure equalization apparatus are reduced. An oleophobic coating of this type can take place, for example, by way of a plasma treatment or by way of a fluorination of the surface, by way of the application of a fluorinated oil or varnish.

The parts which are configured in one piece with the housing and from the same material can further preferably also have an oleophobic coating, that is to say the second protective structure and the fastening projections.

The protective structures can also have an oleophobic coating, and then likewise have the above-described advantages.

The housing and the outer membrane can be covered on the outer side by a cover. It is advantageous here that direct loading of the interior of the pressure equalization apparatus by way of liquid media and/or dust from the surroundings is avoided. The outer membrane is protected satisfactorily by way of the cover against environmental influences and mechanical loading, with the result that the satisfactory use properties are maintained during a long service life.

The outer membrane can be of water-repellent configuration at least on the side which faces the outer side, in such a way that the pressure equalization apparatus preferably has an IPX 6K, IPX 7 or IPX 9K standard in accordance with ISO 20653.

The outer membrane is further preferably not only of water-repellent, but rather also of dust-repellent configuration at least on the side which faces the outer side, with the result that the pressure equalization apparatus preferably achieves an IP6X standard in accordance with the abovementioned regulation.

The inner membrane can be of oil-repellent configuration on the side which faces the inner side, in order to protect the outer membrane as satisfactorily as possible against loading with media which are disadvantageous for the use properties of the outer membrane. To this end, it can be provided that the inner membrane comprises an open-pore structure made from woven fabric or nonwoven, for example from a nonwoven which comprises fibers which are substantially completely coated with an elastomer, as described at the outset in respect of the prior art.

Moreover, the present disclosure relates to the use of a pressure equalization apparatus, as described above, for a machine housing, in which an oleiferous medium is received. The machine housing can be, for example, a transmission housing, an axle housing, or a housing for electric motors, it being possible for the abovementioned machine housings to be used in motor vehicles, trucks, agricultural machines or ships.

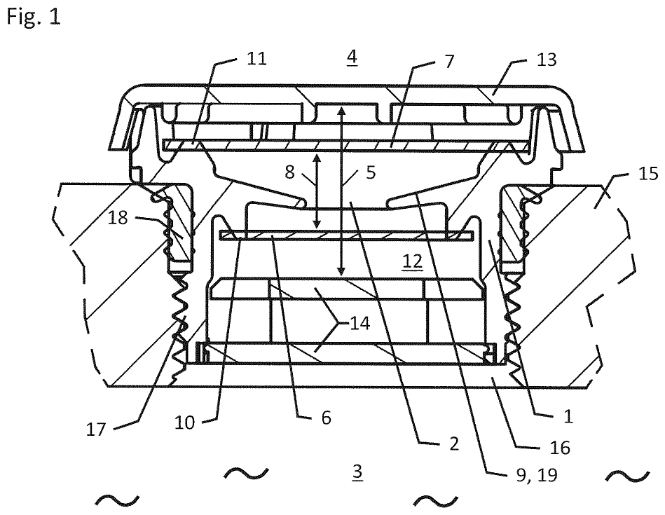

The pressure equalization apparatuses from FIGS. 1 to 3 each comprise the grid-shaped housing 1 which comprises a tough, polymeric material.

In the exemplary embodiments which are shown, the housing 1 of the pressure equalization apparatus is fastened in a recess 16 of the machine housing 15. In these exemplary embodiments, the fastening takes place by way of a screw connection by means of a thread 17, the recess 16 being sealed toward the outer side 4 by way of a seal 18 made from rubber-elastic material. The seal 18 is arranged sealingly between the housing 1 and the machine housing 15 under elastic prestress.

The gas passage opening 2, by way of which the inner side 3 and the outer side 4 of the pressure equalization apparatus are connected in a flow-conducting manner in the flow direction 5, dependent on the differential pressure, is arranged in the housing 1.

The gas passage opening 2 is covered by an inner membrane 6 on the side which faces the inner side 3 and by the outer membrane 7 on the side which faces the outer side 4. The membranes 6, 7 each comprise a gas-permeable material and are arranged in a functional series circuit. The outer membrane 7 is of water-repellent and dust-repellent configuration, in order to prevent a penetration of moisture and contaminants into the interior of the pressure equalization apparatus.

In order to protect the outer membrane 7 against mechanical loads and for further improved protection against the penetration of moisture and contaminants, the housing 1 is provided with the cover 13 which covers the outer membrane 7 on the outer side.

The pressure equalization is not impaired by way of the cover 13 because the cover 13 permits a circulation of air as a result of its configuration, in particular its openings.

The first protective structure 14, the inner membrane 6 and the second protective structure 9 have the task of protecting the outer membrane 7 as satisfactorily as possible against loading with media from the interior of the machine housing 15, in particular against loading with oleiferous media, without the use properties of the pressure equalization apparatus being impaired substantially under this protection. To this end, the inner membrane 6 is of oil-repellent configuration and, in the exemplary embodiment which is shown, comprises an open-pore material. The open-pore material can be a nonwoven or a woven fabric. Although, as described above, the inner membrane 6 is oil-repellent, oil can pass to that side of the inner membrane 6 which faces the outer membrane 7, because the inner membrane 6 is also gas-permeable, just like the outer membrane 7.

In FIG. 1, the second protective structure 9 is configured as a funnel-shaped collar 19.

In order to as reliably as possible prevent loading of the outer membrane 7 with medium from the machine housing and/or from the outer side of the inner membrane 6 during the use as intended of the pressure equalization apparatus, in particular when there is a differential pressure between the inner side 3 and the outer side 4, the first protective structure 14 is first of all provided. Moreover, the annular second protective structure 9 is arranged within the spacing 8 in the flow direction 5 in the form of the collar 19 which, in the exemplary embodiment which is shown, has a central aperture and delimits the gas passage opening 2 on the outer peripheral side.

The inner membrane 6 is arranged on that side of the gas passage opening 2 (here, therefore, of the second protective structure 9) which faces the inner side 3, and the outer membrane 7 is arranged opposite this on the side which faces the outer side 4.

As a result, a great spacing 8 can be provided between the membranes 6, 7, for particularly effective protection of the relatively more sensitive outer membrane 7.

The inner 10 and the outer fastening projection 11 are configured with the second protective structure 9 for fastening the inner 6 and outer membrane 7. By way of the arrangement and the design of the fastening projections 10, 11, the spacing 8 between the membranes 6, 7 can be adapted to the respective conditions of the application. The fastening projections 10, 11 extend in an opposed manner with respect to one another, as viewed in the flow direction 5.

The pressure equalization apparatus has a particularly simple construction with a small number of parts. The housing 1, the second protective structure 9 and the fastening projections 10, 11 are configured so as to merge in one piece into one another and from the same material, and comprise a tough, polymeric material.

In order to minimize an adhesion of medium from the machine housing 15 in the interior of the pressure equalization apparatus, the inner side 12 of the housing 1, the protective structures 9, 14 and the fastening projections 10, 11 have an oleophobic coating. Medium which would adhere in the interior of the housing 1 without an oleophobic coating is discharged in the direction of the machine housing 15 as a result.

In order to minimize loading of the inner membrane 6 with medium from the machine housing 15, the gas-permeable first protective structure 14 is functionally connected upstream of the inner membrane 6 on the side which faces the inner side 3. This first protective structure 14 prevents direct loading of the inner membrane 6 with medium from the machine housing 15.

The outer medium 7 is also particularly satisfactorily protected by virtue of the fact that the inner membrane 6 is already protected by way of the first protective structure 14 against direct loading with medium from the machine housing 15. This protection is highly important, in particular, when the material which the outer membrane 7 comprises would react to loading with medium from the interior of the machine housing 15 with an impairment of its use properties, in particular with an impairment of the gas permeability.

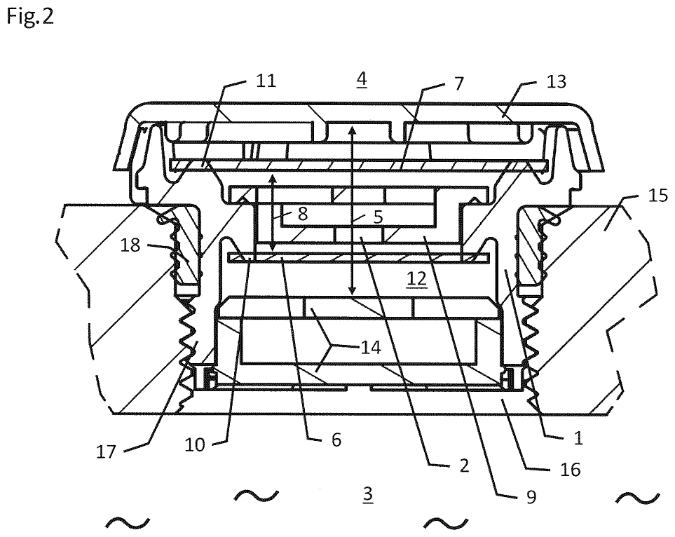

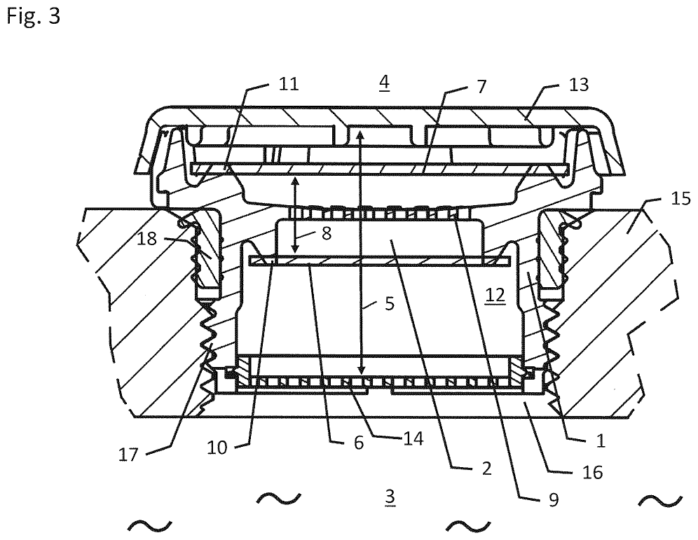

In FIG. 2, the second protective structure 9 is of labyrinthine configuration and, in FIG. 3, the first 14 and second protective structure 9 have apertures. Otherwise, the exemplary embodiments according to FIGS. 2 and 3 do not differ with regard to their function from the exemplary embodiment from FIG. 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A pressure equalization apparatus, comprising:
a grid-shaped housing with a gas passage opening which connects an inner side and an outer side of the pressure equalization apparatus in a flow-conducting manner in a flow direction depending on a differential pressure, the gas passage opening being covered by an inner membrane, arranged toward the inner side, and an outer membrane, arranged toward the outer side, the inner membrane and the outer membrane being arranged in each case in a gas-permeable manner and in a functional series circuit with respect to one another, and the inner membrane and the outer membrane being arranged at a spacing adjacently with respect to one another, as viewed in the flow direction between the inner side and the outer side,
wherein a gas-permeable first protective structure is connected functionally upstream of the inner membrane on a side which faces the inner side, and/or wherein a gas-permeable second protective structure is arranged in the spacing.

2. The pressure equalization apparatus as claimed in claim 1, wherein the second protective structure is formed by an annular collar which delimits the gas passage opening on an outer peripheral side.

3. The pressure equalization apparatus as claimed in claim 2, wherein the collar is of a funnel-shaped configuration.

4. The pressure equalization apparatus as claimed in claim 1, wherein the second protective structure is of a labyrinthine configuration.

5. The pressure equalization apparatus as claimed in claim 1, wherein the first and/or the second protective structure have/has apertures.

6. The pressure equalization apparatus as claimed in claim 1, wherein the second protective structure is configured with an inner fastening projection and an outer fastening projection for fastening the inner membrane and the outer membrane, and wherein the fastening projections extend in the flow direction in an opposed manner with respect to one another.

7. The pressure equalization apparatus as claimed in claim 6, wherein the second protective structure and the inner and outer fastening projections are configured to merge in one piece into one another from the same material.

8. The pressure equalization apparatus as claimed in either of claim 6, wherein the second protective structure, the inner and outer fastening projections and the housing are configured so as to merge in one piece into one another from the same material.

9. The pressure equalization apparatus as claimed in claim 1, wherein the housing comprises a tough, polymeric material.

10. The pressure equalization apparatus as claimed in claim 1, wherein, on a side of the housing which faces the inner and outer membranes, the housing has an inner side which has an oleophobic coating.

11. The pressure equalization apparatus as claimed in claim 1, wherein at least one of the first and second protective structures has an oleophobic coating.

12. The pressure equalization apparatus as claimed in claim 1, wherein the housing and the outer membrane are covered on the outer side by a cover.

13. The pressure equalization apparatus as claimed in claim 1, wherein the outer membrane is of water-repellent configuration at least on a side which faces the outer side.

14. The pressure equalization apparatus as claimed in claim 1, wherein the outer membrane is of dust-repellent configuration at least on a side which faces the outer side.

15. The pressure equalization apparatus as claimed in claim 1, wherein the inner membrane is of oil-repellent configuration at least on a side which faces the inner side.

16. A method, comprising:
providing the pressure equalization apparatus as claimed in claim 1 for a machine housing; and
receiving an oleiferous medium in the pressure equalization apparatus.
